(19) United States
(12) Patent Application Publication
(10) Pub. No.: US 2020/0220434 A1
(43) Pub. Date: Jul. 9, 2020

(54) ROTATION ANGLE DETECTION DEVICE

(71) Applicant: HITACHI AUTOMOTIVE SYSTEMS, LTD., Hitachinaka-shi, Ibaraki (JP)

(72) Inventors: Makoto KIMURA, Yokohama-shi, Kanagawa (JP); Takuro KANAZAWA, Hitachinaka-shi, Ibaraki (JP); Akira MIMA, Mito-shi, Ibaraki (JP)

(73) Assignee: HITACHI AUTOMOTIVE SYSTEMS, LTD., Hitachinaka-shi, Ibaraki (JP)

(21) Appl. No.: 16/647,970

(22) PCT Filed: Sep. 5, 2018
(86) PCT No.: PCT/JP2018/032794

§ 371 Date: Mar. 17, 2020

(30) Foreign Application Priority Data
Sep. 21, 2017 (JP) 2017-181782

(51) Int. Cl. H02K 11/215; H02K 11/22; G01D 5/14

(52) U.S. Cl. CPC H02K 11/215; H02K 11/022; B62D 5/0409; H02K 2211/03; G01D 5/14

(57) ABSTRACT

A first wall portion and a second wall portion of a shield member are provided on a radially outer side of a rotation axis of a motor shaft with respect to a first magnetic sensor in a region other than a region of overlapping the first magnetic sensor on a plane orthogonal to the rotation axis.

### TECHNICAL FIELD

The present invention relates to a rotation angle detection device.

### BACKGROUND ART

In Patent Literature 1, there is disclosed a rotation angle detection device in which a periphery of a magnetic sensor configured to detect a rotation angle of a motor is covered with a magnetic shielding member.

### CITATION LIST

### Patent Literature

[PTL 1] WO 2014/05409 A1

### SUMMARY OF INVENTION

### Technical Problem

However, in the rotation angle detection device described above, the entirety of the magnetic sensor is covered with the magnetic shielding member, and hence there is a problem in that, for example, an installation state of the magnetic sensor cannot be inspected after mounting of the magnetic shielding member.

### Solution to Problem

The present invention has an object to provide a rotation angle detection device that enables an inspection of a magnetic sensor even after mounting of a magnetic shielding member.

According to one embodiment of the present invention, there is provided a rotation angle detection device including a magnetic shielding portion, which is provided in a region other than a region of overlapping a first magnetic sensor on a plane orthogonal to a rotation axis of a rotation member and on a radially outer side of the rotation axis of the rotation member with respect to the first magnetic sensor.

Accordingly, in the rotation angle detection device according to one embodiment of the present invention, the magnetic sensor can be inspected even after mounting of the magnetic shielding member.

### BRIEF DESCRIPTION OF DRAWINGS

FIG. 1 is a configuration view for illustrating an electric power steering device according to a first embodiment.

FIG. 2 is a configuration diagram for illustrating a control system for the electric power steering device.

FIG. 3 is a vertical sectional view for illustrating a main part of a motor unit.

FIG. 4 is a view for illustrating a shield member 47 and choke coils 40 of the first embodiment, as viewed from a Z-axis plus direction side.

FIG. 5 is a perspective view for illustrating the shield member 47 of the first embodiment, as viewed from the Z-axis plus direction side.

FIG. 6 is a perspective view for illustrating a first shield member 60 and a second shield member 61 of a second embodiment, as viewed from the Z-axis plus direction side.

### DESCRIPTION OF EMBODIMENTS

### First Embodiment

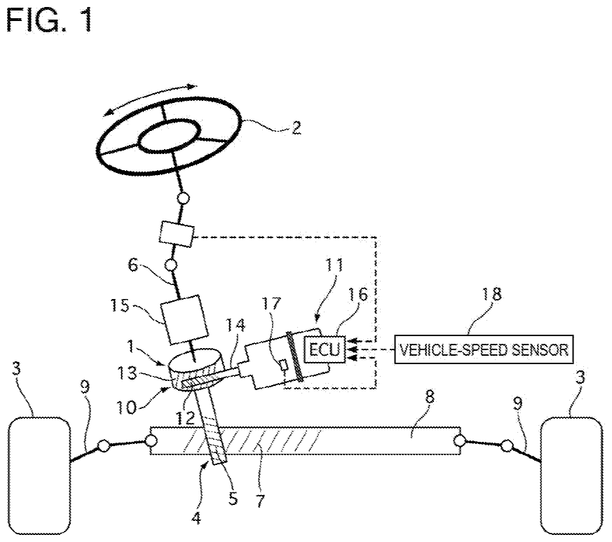

FIG. 1 is a configuration view for illustrating an electric power steering device according to a first embodiment.

A steering mechanism 1 is configured to steer front wheels 3 and 3 with a rotation of a steering wheel 2 and includes a steering gear 4 of a rack-and-pinion type. A pinion gear 5 of the steering gear 4 is coupled to the steering wheel 2 through a steering shaft 6. A rack gear 7 of the steering gear 4 is formed on a rack shaft 8. Both ends of the rack shaft 8 are coupled to the front wheels 3 and 3 through tie rods 9 and 9. An electric motor 11 is coupled to the steering shaft 6 through a speed reducer 10.

The speed reducer 10 includes a worm 12 and a worm wheel 13. The worm 12 rotates integrally with a motor shaft (rotation member) 14 of the electric motor 11. Rotation torque from the motor shaft 14 is transmitted to the steering shalt 6 via the speed reducer 10. A torque sensor 15 configured to detect steering torque is mounted to the steering shaft 6. The electric motor 11 is provided integrally with an ECU 16 and a rotation angle sensor (rotation angle detection device) 17. The rotation angle sensor 17 is configured to detect a motor rotation angle of the electric motor 11. The ECU 16 is configured to control a drive current of the electric motor 11 based on a vehicle speed detected by a vehicle-speed sensor 18 in addition to the steering torque and the motor rotation angle to apply a steering assist force to the steering mechanism 1.

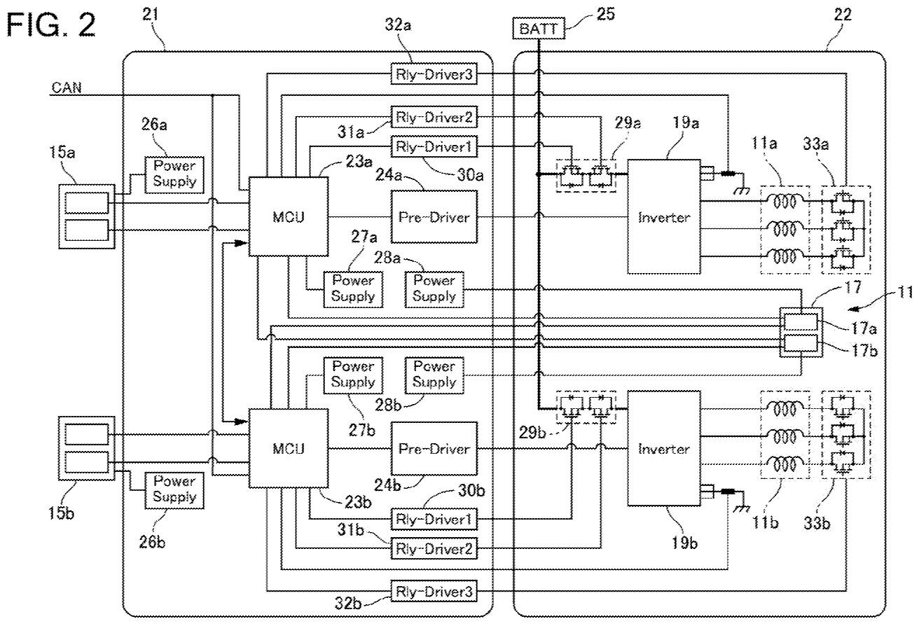

FIG. 2 is a configuration diagram for illustrating a control system for the electric power steering device.

The electric motor 11 is a double three-phase motor including two sets of stators each formed of a three-phase winding (first winding set 11a and second winding set 11b). A maximum motor output that is given when only the first winding set 11a is energized and a maximum motor output that is given when only the second winding set 11b is energized are the same. The electric motor 11 generates assist torque (motor torque) in accordance with a current from an inverter 19. The ECU 16 includes two systems, specifically, a first system for supplying a current to the first winding set 11a and a second system for supplying a current to the second winding set 11b. In the following description, when the systems are to be distinguished, a character “a” is added to an end of a reference symbol of a part corresponding to the first system, and a character “b” is added to an end of a reference symbol of a part corresponding to the second system.

The ECU 16 includes a control board 21 and a power system board 22. The control board 21 is formed of a printed circuit board made of a non-metal base material such as an epoxy resin base material, and control system electronic components such as MCUs 23 and pre-drivers 24 are mounted on both surfaces. The power system board 22 is formed of a printed circuit board made of a non-metal base material such as an epoxy resin base material or a metal excellent in heat transfer characteristic, and the inverters 19 are connected to the power system board 22. The MCU 23 is configured to perform computation for assist control, control for a motor current, detection of abnormality in functional components, and processing of transition to a safe state. The pre-driver 24 is configured to drive a drive element of the inverter 19 based on a command from the MCU 23. The inverter 19 is configured to convert direct-current power from a heavy current battery 25 into alternating-current power and supply the power to the winding sets of the electric motor 11.

The torque sensor 15 is, for example, of a magnetostriction type, and includes two Hall ICs. An output of the torque sensor 15 is input to the MCU 23. The rotation angle sensor 17 includes two magnetic detection elements 17a and 17b. Outputs of the magnetic detection elements 17a and 17b are input to the MCUs 23. A power supply 26 is configured to produce and provide a power source for the torque sensor 15. A power supply 27 is configured to produce and provide a power source for the MCU 23. A power supply 28 is configured to produce and provide a power source for the rotation angle sensor 17. Each of the power supplies 26, 27, and 28 are connected to a weak current battery or an ignition line. Relays 29 are installed on power source lines from the heavy current battery 25 to the inverters 19. Relay drivers 30 and 31 are configured to drive the relays 29 based on commands from the MCUs 23. The winding sets 11a and 11b are connected to relays 33. The relay drivers 32 are configured to drive the relays 33 based on commands from the MCUs 23.

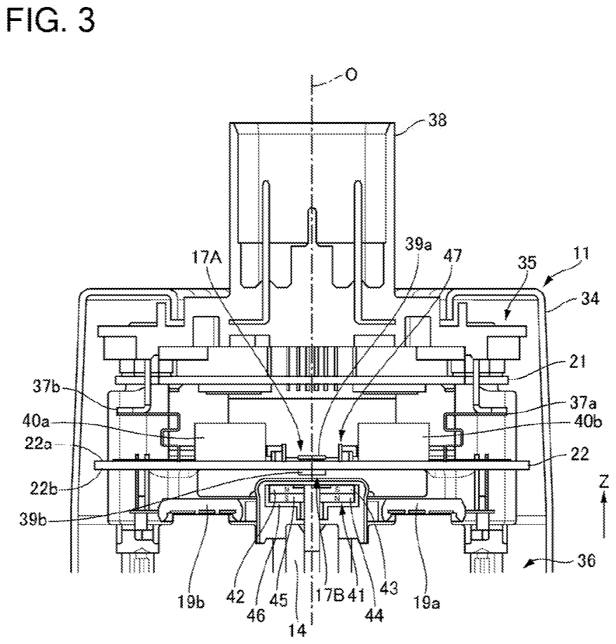

FIG. 3 shows a vertical cross section of a main part of a motor unit.

The motor unit of the first embodiment is a motor unit of a mechatronic integration type in which the electric motor 11, the control board 21, and the power system board 22 are accommodated in one housing 34. The housing 34 is formed into a substantially cylindrical shape by, for example, die-casting of an aluminum alloy. The motor shaft 14 is rotatably accommodated at a center of the housing 34. In the following, a Z-axis is set in a direction along a rotation axis O of the motor shaft 14, and a direction from a lower side toward an upper side on a drawing sheet of FIG. 3 in the Z-axis direction is referred to as “Z-axis plus direction”. Moreover, a radiation direction from the rotation axis O is referred to as “radial direction”, and a direction around the rotation axis O is referred to as “circumferential direction”. The control board 21 and the power system board 22 are installed in a board accommodating portion 35 located on the Z-axis plus direction side with respect to the motor shaft 14. A Z-axis minus direction side of the board accommodating portion 35 is a motor accommodating portion 36 in which the electric motor 11 is installed. The control board 21 is provided on the Z-axis plus direction side with respect to the power system board 22.

The control board 21 and the power system board 22 are fixed to the housing 34 through a support member (not shown) fixed to the housing 34. The control board 21 and the power system board 22 are electrically connected to each other through bus bars 37. Power is supplied to the control board 21 and the power system board 22 through a connector portion 38. When a surface of the power system board 22 on the Z-axis plus direction side is a first surface 22a, and a surface of the power system board 22 on the Z-axis minus direction side is a second surface 22b, a first package 39a is mounted on the first surface 22a, and a second package 39b is mounted on the second surface 22b. The first package 39a accommodates the first magnetic detection element 17a of the rotation angle sensor 17, and the second package 39b accommodates the second magnetic detection element 17b of the rotation angle sensor 17. The packages 39 each have a flat cuboid shape.

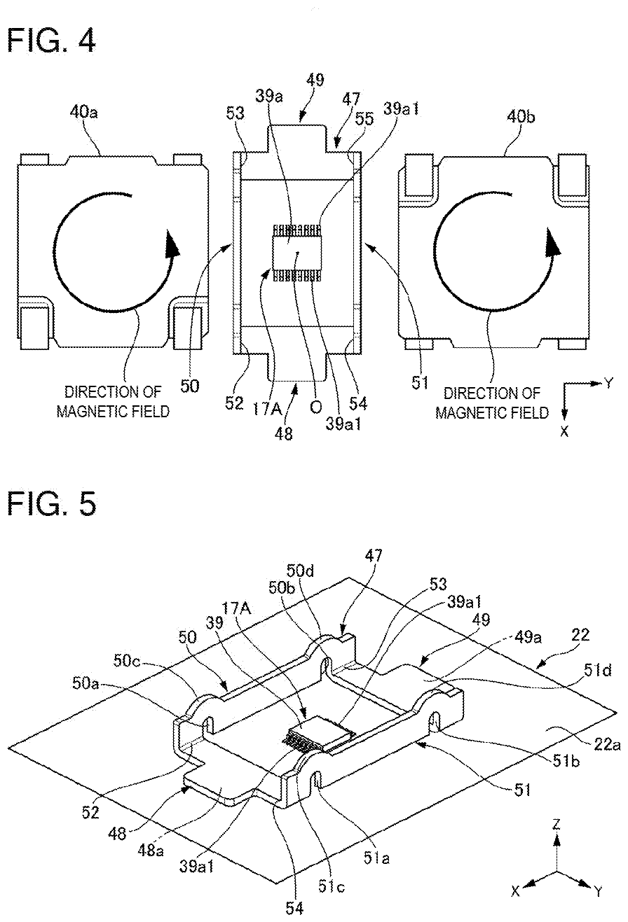

As illustrated in FIG. 4 and FIG. 5, the first package 39a includes a plurality of lead frames 39a1. The lead frames 39a1 support the first magnetic detection element 17a and are connected to a wiring provided on the first surface 22a. The lead frames 39a1 each have a shape extending in a direction orthogonal to the Z-axis. Although illustration is omitted, the second package 39b also includes a plurality of lead frames. In the following, an X-axis is set in a direction in which the lead frames 39a1 extend, and a direction from an upper side toward a lower side on a drawing sheet of FIG. 4 in the X-axis direction is referred to as “X-axis plus direction”. Moreover, a Y-axis is set in a direction orthogonal to both the Z-axis and the X-axis, and a direction from a left side toward a right side on the drawing sheet of FIG. 4 in the Y-axis is referred to as “Y-axis plus direction”.

Common-mode choke coils (hereinafter referred to as “choke coils”) 40 are mounted on the first surface 22a. The choke coils 40 are noise filters, which are installed on the power source lines between the heavy current battery 25 and the winding sets 11a and 11b and are configured to smoothen noises entering through the power source lines and noises generated, for example, by switching of the inverters 19. As illustrated in FIG. 4, a first choke coil (first noise filter) 40a is located on the Y-axis minus direction side with respect to a first magnetic sensor 17A in the Y-axis direction. A second choke coil (second noise filter) 40b is located on the Y-axis plus direction side with respect to the first magnetic sensor 17A in the Y-axis direction. The first choke coil 40a and the second choke coil 40b are installed so that, when viewed from the Z-axis direction, the first choke coil 40a and the second choke coil 40b are arranged in a point symmetry with, each other with a point on the rotation axis O, that is, a rotation center of the motor shaft 14 as a point of symmetry. In each of the first choke coil 40a and the second choke coil 40b, a direction of a current which flows inside thereof is set so as to generate a magnetic field in the direction indicated by the arrow of FIG. 4 (counterclockwise) when viewed from the Z-axis plus direction side.

The rotation axis O of the motor shaft 14 passes through a center of the rotation angle sensor 17 (packages 39a and 39b). That is, in the Z-axis direction, the packages 39a and 39b overlap the rotation axis O. It is not always required that the magnetic detection elements 17a and 17b overlap the rotation axis O. The rotation angle sensor 17 is provided at a position of being opposed to a magnet 41, which rotates integrally with the motor shaft 14, in the Z-axis direction. The rotation angle sensor 17 is a magnetic sensor that is configured to detect a magnitude of or a change in direction of a magnetic field of the magnet 41 to thereby detect a rotation angle of a motor rotor (not shown). In the following, the rotation angle sensor 17 is referred to as “magnetic sensor 17”. Moreover, the first package 39a and the first magnetic detection element 17a are referred to as “first magnetic sensor 17A”, and the second package 39b and the second magnetic detection element 17b are referred to as “second magnetic sensor 17B”.

The magnet 41 is a double-sided four-pole columnar magnet having N-poles and S-poles at positions opposed to each other across the rotation axis O of the motor shaft 14. The N-poles and S-poles of the magnet 41 are formed, for example, through magnetization by a magnetic field generated in the direction of the rotation axis O through use of a magnetization yoke. That is, the magnet 41 is magnetized in a surface direction surface magnetization). The magnet 41 is magnetized with a first N-pole 42 and a first S-pole 43 on the Z-axis plus direction side and is magnetized with a second N-pole 44 and a second S-pole 45 on the Z-axis minus direction side. The second N-pole 44 is located on the Z-axis minus direction side of the first S-pole 43, and the second S-pole 45 is located on the Z-axis minus direction side of the first N-pole 42. The magnet 41 is fixed to a magnet holder 46. The magnet holder 46 is made of the same iron-based material as the motor shaft 14 and has a cylindrical shape.

A shield member 47 being a magnetic shielding member is fixed to the first surface 22a of the power system board 22 by soldering. FIG. 4 is a view for illustrating the shield member 47 and the choke coils 40 of the first embodiment, as viewed from the Z-axis plus direction side. FIG. 5 is a perspective view for illustrating the shield member 47 of the first embodiment, as viewed from the Z-axis plus direction side. The shield member 47 is formed by pressing (punching or bending) a workpiece, which is made of an iron-based material and has a flat plate shape. The shield member 47 is subjected to plating with a material having a higher wettability than that of the power system board 22 in the aim of improving the wettability of soldering. The shield member 47 has a substantially rectangular shape as viewed from the Z-axis direction and surrounds the first magnetic sensor 17A on the first surface 22a. The shield member 47 has a shape of point symmetry with a point on the rotation axis O, that is, the rotation center of the motor shaft 14 as a point of symmetry when viewed from the Z-axis direction., specifically, a shape of two-fold symmetry.

The shield member 47 includes base portions 48 and 49, a first wall portion 50, a second wall portion 51, first bent portions 52 and 53, and second bent portions 54 and 55.

The base portion 48 extends in the Y-axis direction on the X-axis plus direction side of the first magnetic sensor 17A. A height (dimension in the Z-axis direction) of the base portion 48 is smaller than a thickness (dimension in the Z-axis direction) of the first package 39a and a height (dimension in the Z-axis direction) of each of the plurality of lead frames 39a1. A back surface (surface on the Z-axis minus direction side) of the base portion 48 is a first soldering surface 48a which is parallel to the first surface 22a. The first soldering surface 48a is soldered on the first surface 22a. The first soldering surface 48a is insulated from the power system board 22.

The base portion 49 extends in the Y-axis direction on the X-axis minus direction side of the first magnetic sensor 17A. A height of the base portion 49 is smaller than the thickness of the first package 39a and the height of each of the plurality of lead frames 39a 1. A back surface of the base portion 49 is a second soldering surface 49a which is parallel to the first surface 22a. The second soldering surface 49a is soldered on the first surface 22a. The second soldering surface 49a is insulated from the power system board 22.

The first wall portion 50 is a magnetic shielding portion and extends in the X-axis direction on the Y-axis minus direction side of the first magnetic sensor I 7A. The first wall portion 50 stands from the first surface 22a toward the Z-axis plus direction side. That is, the first wall portion 50 is inclined perpendicularly to the first surface 22a. An X-axis plus direction end of the first wall portion 50 is linked to a Y-axis minus direction end of the base portion 48 through the first bent portion 52. An X-axis minus direction end of the first wall portion 50 is linked to a Y-axis minus direction end of the base portion 49 through the first bent portion 53. That is, the first wall portion 50 is formed by bending a workpiece along bending lines. The first bent portions 52 and 53 extend along a direction of the bending lines (X-axis direction). At a Z-axis minus direction end of the first wall portion 50, portions other than the first bent portions 52 and 53 are apart from the first surface 22a. A height (dimension in the Z-axis direction) of the first wall portion 50 is larger than the thickness (dimension in the Z-axis direction) of the first package 39a. Moreover, the height of the first wall portion 50 is set to a height which enables recognition of the first magnetic sensor 17A with an automatic optical inspection device. The automatic optical inspection device is configured to recognize an installation state (for example, a soldering state and a mounting position) of the first magnetic sensor 17A from a position which is located on a radially outer side of the shield member 47 and on the Z-axis plus direction side with respect to the power system board 22. Therefore, it is required that a height of each of the first wall portion 50 and the second wall portion 51 be set to such a height that the first wall portion 50 and the second wall portion 51 do not interrupt between the automatic optical inspection device and the first magnetic sensor 17A.

The first wall portion 50 has groove portions 50a and 50b. The groove portion 50a is adjacent to the first bent portion 52 in the X-axis direction, and the groove portion 50b is adjacent to the first bent portion 53 in the X-axis direction. The groove portions 50a and 50b extend from the Z-axis minus direction end of the first wall portion 50 toward the Z-axis plus direction side. That is, the groove portions 50a and 50b extend in a perpendicular direction (Z-axis direction) with respect to a direction of the bending lines of the first bent portions 52 and 53 (X-axis direction). The first wall portion 50 includes projecting portions 50c and 50d. The projecting portions 50c and 50d are provided on the Z-axis plus direction side of the groove portions 50a and 50b, and each have a substantially arc shape projecting toward the Z-axis plus direction side. The projecting portion 50c is located on the X-axis plus direction side with respect to an X-axis plus direction end of the first package 39a including the lead frames 39a1. The projecting portion 50d is located on the X-axis minus direction side with respect to an X-axis minus direction end of the first package 39a including the lead frames 39a1. That is, the projecting portions 50c and 50d do not overlap the first magnetic sensor 17A in the X-axis direction.

The second wall portion 51 is a magnetic shielding portion and extends in the X-axis direction on the Y-axis plus direction side of the first magnetic sensor 17A. The second wall portion 51 stands from the first surface 22a toward the Z-axis plus direction side. That is, the second wall portion 51 is inclined perpendicularly to the first surface 22a. An X-axis plus direction end of the second wall portion 51 is linked to a Y-axis plus direction end of the base portion 48 through the second bent portion 54. An X-axis minus direction end of the second wall portion 51 is linked to a Y-axis plus direction end of the base portion 49 through the second bent portion 55. That is, the second wall portion 51 is formed by bending a workpiece along bending lines. The second bent portions 54 and 55 extend along a direction of the bending lines (X-axis direction). At a Z-axis minus direction end of the second wall portion 51, portions other than the second bent portions 54 and 55 are apart from the first surface 22a. The height (dimension in the Z-axis direction) of the second wall portion 51 is larger than the thickness (dimension in the Z-axis direction) of the first package 39a. Moreover, the height of the second wall portion 51 is set to a height which enables recognition of the first magnetic sensor 17A with an automatic optical inspection device.

The second wall portion 51 has groove portions 51a and 51b. The groove portion 51a is adjacent to the second bent portion 54 in the X-axis direction, and the groove portion 51b is adjacent to the second bent portion 55 in the X-axis direction. The groove portions 51a and 51b extend from the Z-axis minus direction end of the second wall portion 51 toward the Z-axis plus direction side. That is, the groove portions 51a and 51b extend in a perpendicular direction (Z-axis direction) with respect to a direction of the bending lines of the second bent portions 54 and 55 (X-axis direction). The second wall portion 51 includes projecting portions 51c and 51d. The projecting portions 51c and 51d are provided on the Z-axis plus direction side of the groove portions 51a and 51b, and each have a substantially arc shape projecting toward the Z-axis plus direction side. The projecting portion 51c is located on the X-axis plus direction side with respect to the X-axis plus direction end of the first package 39a including the lead frames 39a1. The projecting portion 51d is located on the X-axis minus direction side with respect to the X-axis minus direction end of the first package 39a including the lead frames 39a1. That is, the projecting portions 51c and 51d do not overlap the first magnetic sensor 17A in the X-axis direction.

Next, actions and effects of the first embodiment are described.

The first wail portion 50 and the second wall portion 51 of the shield member 47 are provided in a region other than the region in which the first wail portion 50 and the second wall portion 51 overlap the first magnetic sensor 17A on a plane orthogonal to the rotation axis O of the motor shaft 14 and on the radially outer side of the rotation axis O with respect to the first magnetic sensor 17A. With this, an external magnetic field is absorbed by the first wall portion 50 and the second wall portion 51, thereby being capable of suppressing the influence of the external magnetic field on a magnetic field between the magnet 41 and the first magnetic sensor 17A. As a result, degradation in accuracy of the first magnetic sensor 17A due to the influence of the external magnetic field can be suppressed.

Moreover, the first wall portion 50 and the second wall portion 51 are not provided in the region in which the first wall portion 50 and the second wall portion 51 overlap the first magnetic sensor 17A on the plane orthogonal to the rotation axis O. Therefore, even after the shield member 47 is mounted to the power system board 22, an installation state (for example, a soldering state and a mounting position) of the first magnetic sensor 17A can be inspected by visual inspection by an operator or through use of an image processing device such as a camera. The first magnetic sensor 17A is opened in the Z-axis direction, but there is substantially no influence of the external magnetic field on the detection accuracy. This is because the first magnetic sensor 17A (magnetic detection element 17a) is configured to detect a magnitude of or a change in direction of the magnetic field in the X-axis direction and the Y-axis direction and has no sensitivity in the Z-axis direction.

The shield member 47 has a shape of surrounding the first magnetic sensor 17A on the first surface 22a of the power system board 22. With this, leakage of a magnetic field, which is formed in the shield member 47, to the outside and a flow of the magnetic field over the first magnetic sensor 17A can be suppressed.

The power system board 22 is a printed circuit board, and the shield member 47 is soldered on the power system board 22. With this, as compared to the fixing with screws, the shield member 47 can be easily mounted at a lower cost.

The shield member 47 includes the first soldering surface 48a and the second soldering surface 49a which are parallel to the first surface 22a of the power system board 22, and the shield member 47 is soldered on the first surface 22a at the first soldering surface 48a and the second soldering surface 49a. With this, at the time of mounting the shield member 47 to the power system board 22, the first soldering surface 48a and the second soldering surface 49a serve as adhesion surfaces, thereby being capable of obtaining higher adhesiveness between the shield member 47 and the power system board 22.

The shield member 47 has a shape of two-fold symmetry with respect to the rotation axis O of the motor shaft 14 on the first surface 22a of the power system board 22. With this, a limitation on a mounting direction of the shield member 47 with respect to the power system board 22 can be reduced, thereby being capable of improving mountability.

The shield member 47 is plated with a material having a wettability higher than that of the power system board 22. With this, bonding between the shield member 47 and the power system board 22 can be improved.

The shield member 47 includes the first soldering surface 48a and the second soldering surface 49a provided apart from the first soldering surface 48a, and a region between the first soldering surface 48a and the second soldering surface 49a is apart from the power system board 22. With the region in which the shield member 47 and the power system board 22 are apart from each other, through arrangement of a printed wiring in this region, interference between the printed wiring and the shield member 47 can be suppressed.

The shield member 47 is insulated from the power system board 22. With this, generation of an unnecessary magnetic field in the shield member 47 due to an inflow of a current from an electric circuit on the power system board 22 to the shield member 47 can be suppressed.

The second magnetic sensor 17B is provided on an extension of the rotation axis O of the motor shaft 14 on the second surface 22b of the power system board 22 and is configured to detect a magnitude of or a change in direction of the magnetic field of the magnet 41. With the redundancy given to the magnetic sensor configured to detect the rotation angle of the magnet 41, a failure of one of the magnetic sensors can be backed up with another of the magnetic sensors.

The shield member 47 includes the base portions 48 and 49, the first wall portion 50, the second wall portion 51, the first bent portions 52 and 53, and the second bent portions 54 and 55. The first wall portion 50 and the second wall portion 51 are inclined at 90° with respect to the first surface 22a of the power system board 22 and are linked to the power system board 22 through the first bent portions 52 and 53 and the second bent portions 54 and 55. That is, with the shield member 47 including the first wall portion 50 and the second wall portion 51 standing from the power system board 22, a magnetic shielding effect against the external magnetic field from the radially outer side of the rotation axis O of the motor shaft 14 can be improved.

The shield member 47 has the groove portions 50a and 50b and the groove portions 51a and 51b formed in the first wall portion 50 and the second wall portion 51. The groove portions 50a and 50b and the groove portions 51a and 51b are formed in the first wall portion 50 and the second wall portion 51 on a side close to the power system board 22 in the direction of the rotation axis O of the motor shaft 14, and have a shape of extending in a direction inclined at 90° with respect to the direction of the bending lines of the first bent portions 52 and 53 and the second bent portions 54 and 55. With this, on both sides across each of the bending lines of the first bent portions 52 and 53 and the second bent portions 54 and 55, a sharp change in width in the bending line direction of the shield member 47 can be suppressed. As a result, the bending characteristics at the first bent portions 52 and 53 and the second bent portions 54 and 55 can be improved.

The shield member 47 includes the projecting portions 50c and 50d and the projecting portions 51c and 51d formed on the first wall portion 50 and the second wall portion 51. The projecting portions 50c and 50d and the projecting portions 51c and 51d are formed on a side opposite to the groove portions 50a and 50b and the groove portions 51a and 51b in the direction of the rotation axis O of the motor shaft 14, and have a shape of projecting toward the side opposite to the groove portions 50a and 50b and the groove portions 51a and 51b. With this, the amount of reduction in sectional areas of the first wall portion 50 and the second wall portion 51 due to formation of the groove portions 50a and 50b and the groove portions 51a and 51b can be canceled with the projecting portions 50c and 50d and the projecting portions 51c and 51d. As a result, a change in sectional area of the first wall portion 50 and the second wall portion 51 can be suppressed, and hence a magnetic resistance is equalized, thereby being capable of improving the magnetic shielding effect.

The projecting portions 50c and 50d and the projecting portions 51c and 51d are formed at positions of not overlapping the first magnetic sensor 17A in a longitudinal direction of the first wall portion 50 and the second wall portion 51 (X-axis direction). With this, at the time of performing an inspection for the installation state of the first magnetic sensor 17A, a hindrance to the inspection by the projecting portions 50c and 50d and the projecting portions 51c and 51d can be suppressed. For example, when the inspection for the installation state of the first magnetic sensor 17A is performed through use of an image processing device such as a camera, an intervention of the projecting portions 50c and 50d or the projecting portions 51c and 51d between the first magnetic sensor 17A and the camera and a hindrance to the image recognition resulting therefrom can be suppressed.

The first wall portion 50 is provided on one side with respect to the first magnetic sensor 17A in the direction of an orthogonal axis (Y-axis direction) orthogonal to the rotation axis O of the motor shaft 14, and the second wall portion 51 is provided on a side opposite to the first wall portion 50 with respect to the first magnetic sensor 17A in the direction of the orthogonal axis. The first magnetic sensor 17A includes the plurality of lead frames 39a1, and the plurality of lead frames 39a1 each have a shape of extending in the direction of the axis orthogonal to both the rotation axis O and the orthogonal axis. The plurality of lead frames 39a1 extend in the direction in which the first wall portion 50 and the second wall portion 51 are not provided. Therefore, for example, when the inspection for the installation state of the lead frames 39a1 is performed through use of an image processing device such as a camera, an intervention of the first wall portion 50 and the second wall portion 51 between the plurality of lead frames 39a1 and the camera and a hindrance to the image recognition resulting therefrom can be suppressed.

The first choke coil 40a and the second choke coil 40h are provided to the power system board 22. The first choke coil 40a is provided on the side opposite to the first magnetic sensor 17A with respect to the first wall portion 50 in the direction of the orthogonal axis (Y-axis direction) orthogonal to the rotation axis O of the motor shaft 14. The second choke coil 40b is provided on the side opposite to the first magnetic sensor 17A with respect to the second wall portion 51 in the direction of the orthogonal axis orthogonal to the rotation axis O of the motor shaft 14. When the first choke coil 40a and the second choke coil 40b being noise filters are provided on the power system board 22, in some cases, the first choke coil 40a and the second choke coil 40b may be a generation source of the external magnetic field. Accordingly, when the first wall portion 50 is provided between the first choke coil 40a and the first magnetic sensor 17A, and the second wall portion 51 is provided between the second choke coil 40b and the first magnetic sensor 17A, the influence of the magnetic field from the first choke coil 40a and the second choke coil 40b on the first magnetic sensor 17A can be suppressed.

The first choke coil 40a and the second choke coil 40b are provided so that directions of the magnetic fields generated by the first choke coil 40a and the second choke coil 40b become reverse to each other in the region in which the first magnetic sensor 17A is provided. With this, the magnetic fields generated by the first choke coil 40a and the second choke coil 40b are canceled out with each, other, thereby being capable of suppressing the influence of the magnetic fields generated by the first choke coil 40a and the second choke coil 40b on the first magnetic sensor 17A.

The first choke coil 40a and the second choke coil 40b are provided at positions symmetrical with each other with respect to the first magnetic sensor 17A in the direction of the orthogonal axis (Y-axis direction). With this, the amount of canceling out the magnetic fields generated by the first choke coil 40a and the second choke coil 40b can be optimized.

The height of each of the first wall portion 50 and the second wall portion 51 in the direction of the rotation axis O of the motor shaft 14 is larger than the thickness of the first magnetic sensor 17A. With this, the influence of the external magnetic field from the radially outer side in the rotation axis O can be effectively suppressed.

The height of each of the first wall portion 50 and the second wall portion 51 in the direction of the rotation axis O of the motor shaft 14 is set to a height which enables recognition of the first magnetic sensor 17A with the automatic optical inspection device. With this, the inspection with the automatic optical inspection device can be performed.

The magnet 41 is magnetized in the direction of the rotation axis O of the motor shaft 14. The first N-pole 42 and the first S-pole 43 are magnetized on one side of the magnet 41 in the direction of the rotation axis O. On another side of the magnet 41 in the direction of the rotation axis O, the second S-pole 45 is magnetized at a position corresponding to the first N-pole 42, and the second N-pole 44 is magnetized at a position corresponding to the first S-pole 43. That is, the magnet 41 is a magnet of so-called surface magnetization, and hence magnetic fluxes deviated from the direction of the rotation axis O in the magnetic field generated by the magnet 41 are formed so as to flow around to the opposite side on the rotation axis O. Accordingly, the magnetic fluxes are efficiently generated with respect to the first magnetic sensor 17A provided on the extension of the rotation axis O, thereby being capable of improving the magnetic detection accuracy of the first magnetic sensor 17A.

### Second Embodiment

Next, a second embodiment is described. Configurations which are the same as those of the first embodiment are denoted by the same reference symbols to omit the description, and only portions different from those of the first embodiment are described.

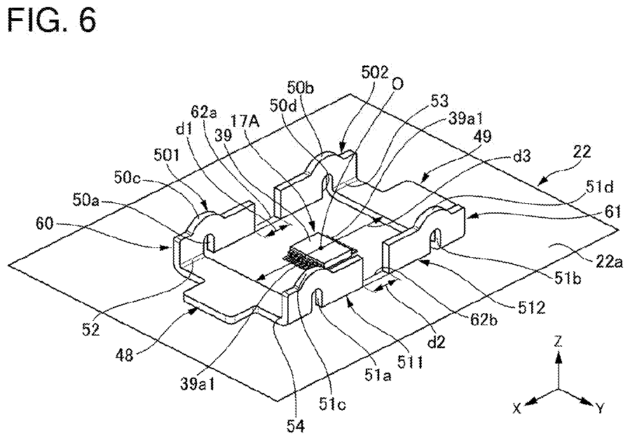

FIG. 6 is a perspective view for illustrating a first shield member 60 and a second shield member 61 of the second embodiment, as viewed from the Z-axis plus direction side. In the second embodiment, the two shield members 60 and 61 are provided as the magnetic shielding members.

The first shield member 60 includes the base portion 48, a first wall portion 501, a second wall portion 511, the first bent portion 52, and the second bent portion 54. The first wall portion 501 is a magnetic shielding portion and extends in the X-axis direction on the Y-axis minus side of the first magnetic sensor 17A. The first wall portion 501 stands from the first surface 22a toward the Z-axis plus direction side. The first wall portion 501 is linked to the base portion 48 through the first bent portion 52. The first wall portion 501 has the groove portion 50a and the projecting portion 50c. The second wall portion 511 is a magnetic shielding portion and extends in the X-axis direction on the Y-axis plus direction side of the first magnetic sensor 17A. The second wall portion 511 stands from the first surface 22a toward the Z-axis plus direction side. The second wall portion 511 is linked to the base portion 48 through the second bent portion 54. The second wall portion 511 has the groove portion 51a and the projecting portion 51c. A height of each of the first wall portion 501 and the second wall portion 511 is the same as that of the first wall portion 50 of the first embodiment.

The second shield member 61 includes the base portion 49, a first wall portion 502, a second wall portion 512, the first bent portion 53, and the second bent portion 55. The first wall portion 502 is a magnetic shielding member and extends in the X-axis direction on the Y-axis minus side of the first magnetic sensor 17A. The first wall portion 502 stands from the first surface 22a in the Z-axis plus direction. The first wall portion 502 is linked to the base portion 49 through the first bent portion 53. The first wall portion 502 has the groove portion 50b and the projecting portion 50d. The second wall portion 512 is a magnetic shielding member and extends in the X-axis direction on the Y-axis plus direction side of the first magnetic sensor 17A. The first wall portion 502 stands from the first surface 22a in the Z-axis plus direction. The second wall portion 512 is linked to the base portion 49 through the second bent portion 55 (not shown). The second wall portion 512 has the groove portion 51b and the projecting portion 51d. A height of each of the first wall portion 502 and the second wall portion 512 is the same as that of the second wall portion 51 of the first embodiment.

The height (dimension in the Z-axis direction) of each of the first wall portions 501 and 502 and the second wall portions 511 and 512 is larger than the thickness (dimension in the Z-axis direction) of the first package 39a. Moreover, the height of each of the first wall portions 501 and 502 and the second wall portions 511 and 512 is set to a height which enables recognition of the first magnetic sensor 17A with the automatic optical inspection device.

In the X-axis direction, a distance d1 between the first wall portion 501 and the first wall portion 502 is smaller than a distance d3 between the base portion 48 and the base portion 49. Moreover, in the X-axis direction, a distance d2 between the second wall portion 511 and the second wall portion 512 is equal to the distance d1.

The first wall portion 501 and the first wall portion 502 are magnetically connected to each other through a printed wiring 62a on the power system board 22. Moreover, the second wall portion 511 and the second wall portion 512 are magnetically connected to each other through a printed wiring 62b on the power system board 22.

Next, actions and effects of the second embodiment are described.

In the second embodiment, the first shield member 60 and the second shield member 61 are provided as the magnetic shielding members. The first shield member 60 is provided on one side with respect to the first magnetic sensor 17A in the direction of the orthogonal axis (X-axis direction) orthogonal to the rotation axis O of the motor shaft 14. The second shield member 61 is apart from the first shield member 60 and is provided on the side opposite to the first shield member 60 with respect to the first magnetic sensor 17A in the direction of the orthogonal axis. The first shield member 60 and the second shield member 61 are provided so that the distance d3 between the first shield member 60 and the second shield member 61 on the orthogonal axis is longer than a shortest distance d1 (d2) between the first shield member 60 and the second shield member 61.

The first shield member 60 and the second shield member 61 are apart from each other, and hence there is a case in which a magnetic field flows between the first shield member 60 and the second shield member 61 through the air. The magnetic field tends to flow in the shortest distance between members having a small magnetic resistance. Thus, when portions (first wall portions 501 and 502 and second wall portions 511 and 512) which bring the first shield member 60 and the second shield member 61 close to each other are provided, the flow of the magnetic field over the first magnetic sensor 17A on the orthogonal axis is suppressed. As a result, the influence of the magnetic field that flows between the first shield member 60 and the second shield member 61 on the magnetic field detected by the first magnetic sensor 17A can be suppressed.

The printed wirings 62a and 62b printed on the power system board 22 magnetically connect the first wall portion 501 and the second wall portion 511 of the first shield member 60 to the first wall portion 502 and the second wall portion. 512 of the second shield member 61. The magnetic field which flows between the first shield member 60 and the second shield member 61 is more likely to flow on the printed wirings 62a and 62b. Therefore, the influence of the magnetic field which flows between the first shield member 60 and the second shield member 61 on the magnetic field detected by the first magnetic sensor 17A can be further suppressed.

### Other Embodiments

The embodiments for carrying out the present invention have been described above. However, the specific configuration of the present invention is not limited to the configurations described in the embodiments. A change in design without departing from the scope of the gist of the invention is encompassed in the present invention.

The magnet may be a magnet having one N-pole and one S-pole in the circumferential direction or may be a magnet having a plurality of N-poles and a plurality of S-poles.

As the noise filter, there may be used a ferrite core in place of the common-mode choke coil.

An inclination angle of each of the first wall portion and the second wall portion with respect to the power system board may be an angle other than the right angle.

Technical ideas obtained from the embodiments described above are described below.

The rotation angle detection device is, in one mode thereof, a rotation angle detection device which is configured to detect a rotation angle of a rotation member, including: a magnet, which is provided to the rotation member, and includes an N-pole and S-pole arranged in a circumferential direction of a rotation axis of the rotation member; a board, which is provided apart from the magnet in a direction of the rotation axis of the rotation member, and includes a first surface on one side in the direction of the rotation axis of the rotation member and a second surface on another side; a first magnetic sensor including a magnetic detection element and a package, the magnetic detection element being configured to detect a magnitude of or a change in direction of a magnetic field of the magnet, the package being provided on an extension of the rotation axis of the rotation member on the first surface of the board and being configured to accommodate the magnetic detection element inside the package; and a magnetic shielding member including a magnetic shielding portion, which is made of a magnetic material, and is provided to the first surface of the board, the magnetic shielding portion being provided in a region other than a region of overlapping the first magnetic sensor on a plane orthogonal to the rotation axis of the rotation member and on a radially outer side of the rotation axis of the rotation member with respect to the first magnetic sensor.

In a more preferred mode, in the mode described above, the magnetic shielding member includes a first magnetic shielding member and a second magnetic shielding member; the first magnetic shielding member is provided on one side with respect to the first magnetic sensor in a direction of an orthogonal axis orthogonal to the rotation axis of the rotation member; the second magnetic shielding member is apart from the first magnetic shielding member, and is provided on a side opposite to the first magnetic shielding member with respect to the first magnetic sensor in the direction of the orthogonal axis; and the first magnetic shielding member and the second magnetic shielding member are provided so that a distance between the first magnetic shielding member and the second magnetic shielding member on the orthogonal axis is longer than a shortest distance between the first magnetic shielding member and the second magnetic shielding member.

In another preferred mode, in any one of the modes described above, the rotation angle detection device includes a printed wiring; and the printed wiring is printed on the board and is configured to magnetically connect the first magnetic shielding member and the second magnetic shielding member to each other.

In another preferred mode, in any one of the modes described above, the magnetic shielding member has a shape of surrounding the first magnetic sensor on the first surface of the board.

In still another preferred mode, in any one of the modes described above, the board is a printed circuit board; and the magnetic shielding member is soldered on the board.

In still another preferred mode, in any one of the modes described above, the magnetic shielding member includes a soldering surface which is parallel to the first surface of the board; and the soldering surface is soldered on the first surface of the board.

In still another preferred mode, in any one of the modes described above, the magnetic shielding member has a symmetrical shape with respect to the rotation axis of the rotation member on the first surface of the board.

In still another preferred mode, in any one of the modes described above, the magnetic shielding member is plated with a material having a wettability higher than a wettability of the board.

In still another preferred mode, in any one of the modes described above, the magnetic shielding member includes a first soldering surface and a second soldering surface provided apart from the first soldering surface, and a region between the first soldering surface and the second soldering surface is apart from the board.

In still another preferred mode, in any one of the modes described above, the magnetic shielding member is insulated from the board.

In still another preferred mode, in any one of the modes described above, the second magnetic sensor is provided on an extension of the rotation axis of the rotation member on the second surface of the board and is configured to detect a magnitude of or a change in direction of a magnetic field of the magnet.

In still another preferred mode, in any one of the modes described above, the magnetic shielding member includes a base portion, a bent portion, and a wall portion; and the wall portion is inclined with respect to the first surface of the board and is linked to the base portion through the bent portion.

In still another preferred mode, in any one of the modes described above, the magnetic shielding member has a groove portion formed in the wall portion; the groove portion has a shape of being formed on a side close to the board in the wall portion in the direction of the rotation axis of the rotation member; the shape is provided adjacent to the bent portion; and the shape extends in a direction of inclining with respect to a direction of a bending line of the bent portion.

In still another preferred mode, in any one of the modes described above, the magnetic shielding member includes a projecting portion formed on the wall portion; and the projecting portion has a shape which is formed on a side opposite to the groove portion in the direction of the rotation axis of the rotation member and projects toward the side opposite to the groove portion.

In still another preferred mode, in any one of the modes described above, the projecting portion is formed at a position of not overlapping the first magnetic sensor in a longitudinal direction of the wall portion.

In still another preferred mode, in any one of the modes described above, the magnetic shielding member includes a base portion, a first bent portion, a second bent portion, a first wall portion, and a second wall portion; the first wall portion is provided on one side with respect to the first magnetic sensor in a direction of an orthogonal axis orthogonal to the rotation axis of the rotation member, is inclined with respect to the first suffice of the board, and is linked to the base portion through the first bent portion; the second wall portion is provided on a side opposite to the first wall portion with respect to the first magnetic sensor in the direction of the orthogonal axis, is inclined with respect to the first surface of the board, and is linked to the base portion through the second bent portion, and the first magnetic sensor includes a plurality of lead frames; and the plurality of lead frames each have a shape of extending in a direction of an axis orthogonal to both the rotation axis of the rotation member and the orthogonal axis.

In still another preferred mode, in any one of the modes described above, the rotation angle detection device further includes a first noise filter and a second noise filter provided on the board; the magnetic shielding member includes a base portion, a first bent portion, a second bent portion, a first wall portion, and a second wall portion; the first wall portion is provided on one side with respect to the first magnetic sensor in a direction of an orthogonal axis orthogonal to the rotation axis of the rotation member, is inclined with respect to the first surface of the board, and is linked to the base portion through the first bent portion; the second wall portion is provided on a side opposite to the first wall portion with respect to the first magnetic sensor in the direction of the orthogonal axis, is inclined with respect to the first surface of the board, and is linked to the base portion through the second bent portion, the first noise filter is provided on a side opposite to the first magnetic sensor with respect to the first wall portion in the direction of the orthogonal axis; and the second noise filter is provided on a side opposite to the first magnetic sensor with respect to the second wall portion in the direction of the orthogonal axis.

In still another preferred mode, in any one of the modes described above, the first noise filter and the second noise filter are provided so that directions of magnetic fields generated by the first noise filter and the second noise filter are reverse to each other in a region in which the first magnetic sensor is provided.

In still another preferred mode, in any one of the modes described above, the first noise filter and the second noise filter are provided at positions symmetrical with each other with respect to the first magnetic sensor in the direction of the orthogonal axis.

In still another preferred mode, in any one of the modes described above, a height of the wall portion in the direction of the rotation axis of the rotation member is larger than a thickness of the first magnetic sensor.

In still another preferred mode, in any one of the modes described above, the height of the wall portion in the direction of the rotation axis of the rotation member is a height which enables recognition of the first magnetic sensor with an automatic optical inspection device.

In still another preferred mode, in any one of the modes described above, the magnet is magnetized in the direction of the rotation axis of the rotation member; a first N-pole and a first S-pole are magnetized on one side of the magnet in the direction of the rotation axis of the rotation member; a second S-pole is magnetized at a position corresponding to the first N-pole on another side of the magnet in the direction of the rotation axis of the rotation member; and a second N-pole is magnetized at a position corresponding to the first S-pole.

Note that, the present invention is not limited to the above-mentioned embodiments, and includes further various modification examples. For example, in the above-mentioned embodiments, the configurations are described in detail in order to clearly describe the present invention, but the present invention is not necessarily limited to an embodiment that includes all the configurations that have been described. Further, a part of the configuration of a given embodiment can replace the configuration of another embodiment, and the configuration of another embodiment can also be added to the configuration of a given embodiment. Further, another configuration can be added to, deleted from, and replace a part of the configuration of each of the embodiments.

The present application claims a priority based on Japanese Patent Application No. 2017-181782 filed on Sep. 21, 2017. All disclosed contents including Specification, Scope of Claims, Drawings, and Abstract of Japanese Patent Application No. 2017-181782 filed on Sep. 21, 2017 are incorporated herein by reference in their entirety.

### REFERENCE SIGNS LIST

14 motor shaft (rotation member), 17 rotation angle sensor (rotation angle detection device), 17A first magnetic sensor, 17B second magnetic sensor, 17a first magnetic detection element, 17b second magnetic detection element, 22 power system board (board), 22a first surface, 22b second surface, 39a first package, 39a1 lead frame, 39b second package, 40a first choke coil (first noise filter), 40b second choke coil (second noise filter), 41 magnet, 47 shield member (magnetic shielding member), 48, 49 base portion, 48a first soldering surface, 49a second soldering surface, 50 first wall portion (magnetic shielding portion), 50a, 50b groove portion, 50c, 50d projecting portion, 51 second wall portion (magnetic shielding portion), 51a, 51b groove portion, 51c, 51d projecting portion, 52, 53 first bent portion, 54, 55 second bent portion, 60 first shield member (first magnetic shielding member), 61 second shield member (second magnetic shielding member), 62a, 62b printed wiring, O rotation axis

1. A rotation angle detection device, which is configured to detect a rotation angle of a rotation member, the rotation angle detection device comprising:
a magnet, which is provided to the rotation member, and includes an. N-pole and an S-pole arranged in a circumferential direction of a rotation axis of the rotation member;
a board, which is provided apart from the magnet in a direction of the rotation axis of the rotation member, and includes a first surface on one side in the direction of the rotation axis of the rotation member and a second surface on another side in the direction of the rotation axis of the rotation member;
a first magnetic sensor including a magnetic detection element and a package,
the magnetic detection element being configured to detect a magnitude of or a change in direction of a magnetic field of the magnet,
the package being provided on an extension of the rotation axis of the rotation member on the first surface of the board and being configured to accommodate the magnetic detection element inside the package; and
a magnetic shielding member including a magnetic shielding portion, which is made of a magnetic material, and is provided to the first surface of the board,
the magnetic shielding portion being provided in a region other than a region of overlapping the first magnetic sensor on a plane orthogonal to the rotation axis of the rotation member and on a radially outer side of the rotation axis of the rotation member with respect to the first magnetic sensor.

2. The rotation angle detection device according to claim 1,
wherein the magnetic shielding member includes a first magnetic shielding member and a second magnetic shielding member,
wherein the first magnetic shielding member is provided on one side with respect to the first magnetic sensor in a direction of an orthogonal axis orthogonal to the rotation axis of the rotation member,
wherein the second magnetic shielding member is apart from the first magnetic shielding member, and is provided on a side opposite to the first magnetic shielding member with respect to the first magnetic sensor in the direction of the orthogonal axis, and
wherein the first magnetic shielding member and the second magnetic shielding member are provided so that a distance between the first magnetic shielding member and the second magnetic shielding member on the orthogonal axis is longer than a shortest distance between the first magnetic shielding member and the second magnetic shielding member.

3. The rotation angle detection device according to claim 2,
wherein the rotation angle detection device includes a printed wiring, and
wherein the printed wiring is printed on the board and is configured to magnetically connect the first magnetic shielding member and the second magnetic shielding member to each other.

4. The rotation angle detection device according to claim 1, wherein the magnetic shielding member has a shape of surrounding the first magnetic sensor on the first surface of the board.

5. The rotation angle detection device according to claim 1,
wherein the board is a printed circuit board, and
wherein the magnetic shielding member is soldered on the board.

6. The rotation angle detection device according to claim 5,
wherein the magnetic shielding member includes a soldering surface which is parallel to the first surface of the board, and
wherein the soldering surface is soldered on the first surface of the board.

7. The rotation angle detection device according to claim 5, wherein the magnetic shielding member has a symmetrical shape with respect to the rotation axis of the rotation member on the first surface of the board.

8. The rotation angle detection device according to claim 5, wherein the magnetic shielding member is plated with a material having a wettability higher than a wettability of the board.

9. The rotation angle detection device according to claim 5, wherein the magnetic shielding member includes a first soldering surface and a second soldering surface provided apart from the first soldering surface, and a region between the first soldering surface and the second soldering surface is apart from the board.

10. The rotation angle detection device according to claim 5, wherein the magnetic shielding member is insulated from the board.

11. The rotation angle detection device according to claim 1, further comprising a second magnetic sensor,
wherein the second magnetic sensor is provided on an extension of the rotation axis of the rotation member on the second surface of the board and is configured to detect a magnitude of or a change in direction of a magnetic field of the magnet.

12. The rotation angle detection device according to claim 1,
wherein the magnetic shielding member includes a base portion, a bent portion, and a wall portion, and
wherein the wall portion is inclined with respect to the first surface of the board and is linked to the base portion through the bent portion.

13. The rotation angle detection device according to claim 12,
wherein the magnetic shielding member has a groove portion formed in the wall portion,
wherein the groove portion has a shape of being formed on a side close to the board in the wall portion in the direction of the rotation axis of the rotation member,
wherein the shape is provided adjacent to the bent portion, and
wherein the shape extends in a direction of inclining with respect to a direction of a bending line of the bent portion.

14. The rotation angle detection device according to claim 13, wherein the magnetic shielding member includes a projecting portion formed on the wall portion, and
wherein the projecting portion has a shape which is formed on a side opposite to the groove portion in the direction of the rotation axis of the rotation member and projects toward the side opposite to the groove portion.

15. The rotation angle detection device according to claim 14, wherein the projecting portion is formed at a position of not overlapping the first magnetic sensor in a longitudinal direction of the wall portion.

16. The rotation angle detection device according to claim 12,
wherein the magnetic shielding member includes a base portion, a first bent portion, a second bent portion, a first wall portion, and a second wall portion,
wherein the first wall portion is provided on one side with respect to the first magnetic sensor in a direction of an orthogonal axis orthogonal to the rotation axis of the rotation member, is inclined with respect to the first surface of the board, and is linked to the base portion through the first bent portion,
wherein the second wall portion is provided on a side opposite to the first wall portion with respect to the first magnetic sensor in the direction of the orthogonal axis, is inclined with respect to the first surface of the board, and is linked to the base portion through the second bent portion, and the first magnetic sensor includes a plurality of lead frames, and
wherein the plurality of lead frames each have a shape of extending in a direction of an axis orthogonal to both the rotation axis of the rotation member and the orthogonal axis.

17. The rotation angle detection device according to claim 12, further comprising a first noise filter and a second noise filter provided on the board,
wherein the magnetic shielding member includes a base portion, a first bent portion, a second bent portion, a first wall portion, and a second wall portion,
wherein the first wall portion is provided on one side with respect to the first magnetic sensor in a direction of an orthogonal axis orthogonal to the rotation axis of the rotation member, is inclined with respect to the first surface of the board, and is linked to the base portion through the first bent portion,
wherein the second wall portion is provided on a side opposite to the first wall portion with respect to the first magnetic sensor in the direction of the orthogonal axis, is inclined with respect to the first surface of the board, and is linked to the base portion through the second bent portion,
wherein the first noise filter is provided on a side opposite to the first magnetic sensor with respect to the first wall portion in the direction of the orthogonal axis, and
wherein the second noise filter is provided on a side opposite to the first magnetic sensor with respect to the second wall portion in the direction of the orthogonal axis.

18. The rotation angle detection device according to claim 17, wherein the first noise filter and the second noise filter are provided so that directions of magnetic fields generated by the first noise filter and the second noise filter are reverse to each other in a region in which the first magnetic sensor is provided.

19. The rotation angle detection device according to claim 18, wherein the first noise filter and the second noise filter are provided at positions symmetrical with each other with respect to the first magnetic sensor in the direction of the orthogonal axis.

20. The rotation angle detection device according to claim 12, wherein a height of the wall portion in the direction of the rotation axis of the rotation member is larger than a thickness of the first magnetic sensor.

21. The rotation angle detection device according to claim 20, wherein the height of the wall portion in the direction of the rotation axis of the rotation member is a height which enables recognition of the first magnetic sensor with an automatic optical inspection device.

22. The rotation angle detection device according to claim 1,
wherein the magnet is magnetized in the direction of the rotation axis of the rotation member,
wherein a first N-pole and a first S-pole are magnetized on one side of the magnet in the direction of the rotation axis of the rotation member,
wherein a second S-pole is magnetized at a position corresponding to the first N-pole on another side of the magnet in the direction of the rotation axis of the rotation member, and
wherein a second N-pole is magnetized at a position corresponding to the first S-pole on the another side of the magnet in the direction of the rotation axis of the rotation member.
